(19) United States
(12) Patent Application Publication
(10) Pub. No.: US 2021/0071957 A1
(43) Pub. Date: Mar. 11, 2021

(54) APPARATUS INCLUDING AN INSULATED CASE AND CAMERA FOR HIGH TEMPERATURE SETTINGS

(71) Applicant: DENSO International America, Inc., Southfield, MI (US)

(72) Inventor: Randy CRUSCIEL, Battle Creek, MI (US)

(21) Appl. No.: 16/567,195

(22) Filed: Sep. 11, 2019

(51) Int. Cl. F27D 21/02

(52) U.S. Cl. CPC F27D 21/02; F27D 2021/026

(57) ABSTRACT

An insulated case includes a top portion and a bottom portion of the insulated case. The bottom portion include a metallic shell and an insulation portion. The bottom portion also includes a cut-out located on an outer side of the metallic shell. The insulated case also includes a component storage area that includes a camera, an energy source, a digital recorder, and a coolant, wherein the component storage area is sealed off. The insulated case also includes a camera located in the component storage area. The camera is configured to capture videos via the cut-out.

### TECHNICAL FIELD

The present disclosure relates to an insulated case with a camera.

### BACKGROUND

High-temperature furnaces may need maintenance periodically. However, high temperature situations may make it difficult for such furnaces to be examined. An issue with conducting preventive maintenance in a high-temperature furnace is that it takes several days for such a furnace to cool down to room temperature to make inspection safe. Additionally, to reheat the furnace, it may take several days.

### SUMMARY

According to one embodiment, an insulated case includes a top portion and a bottom portion of the insulated case, wherein bottom portion include a metallic shell and an insulation portion, wherein the bottom portion includes a cut-out located on an outer side of the metallic shell. The insulated case also includes a component storage area that includes a camera, an energy source, a digital recorder, and a coolant, wherein the component storage area is sealed off. The insulated case also includes a camera located in the component storage area. The camera is configured to capture videos via the second cut-out.

According to one embodiment, an insulated case includes a top portion and a bottom portion of the insulated case, wherein the top and bottom portion include a metallic shell and an insulated portion filled with insulation, wherein the bottom portion includes a first cut-out and a second cut-out located on an outer side of the bottom portion, wherein the second cut-out includes a receiving socket for a light bulb. The insulated case also includes a component storage area that includes a camera area with access to the first cut-out, and a cooling area, wherein the component storage area is surrounded by the insulation portion and the component storage area is further defined by a perimeter, wherein the insulation portion of the top portion seals the component storage area when the top portion is secured to the bottom portion.

According to one embodiment, an insulated case includes a top portion and a bottom portion of the insulated case, wherein the top and bottom portion include a metallic shell and an insulated portion filled with insulation, wherein the bottom portion includes a first cut-out located on an outer side of the bottom portion. The insulated case includes a component storage area located in the bottom portion and that includes a camera area with access to the first cut-out, wherein the component storage area further a cooling area that allows air flow to the camera area of the component storage area, wherein the component storage area is surrounded by the insulation portion of the bottom portion and the component storage area is defined by a metallic perimeter, wherein the component storage area is sealed off from the insulated portion when the top portion and the bottom portion of the case is assembled.

### BRIEF DESCRIPTION OF THE DRAWINGS

FIG. 1 is an embodiment of an insulated case 100 opened.

FIG. 2 is a front view of the insulated case 100.

FIG. 3 is a perspective top view of a top portion of the insulated case 100.

FIG. 4 is a perspective view of the insulated case 100 with a light cover secured.

FIG. 5 is a front view of the bottom portion of the insulated case with a light bulb and light cover removed.

FIG. 6 is a perceptive view of a side portion of the insulated case 100.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

High-temperature furnaces may need periodic maintenance. However, high temperature situations may make it difficult for such furnaces to be examined. An issue with conducting preventive maintenance in a high-temperature furnace is that it takes several days for the furnace to cool down to room temperature to make inspection safe. Additionally, to reheat the furnace, it may take several days. The insulated case in the present disclosure allows for a camera to examine and capture images or recordings of the furnace in a high temperature setting, thus avoiding any cool off or heating period.

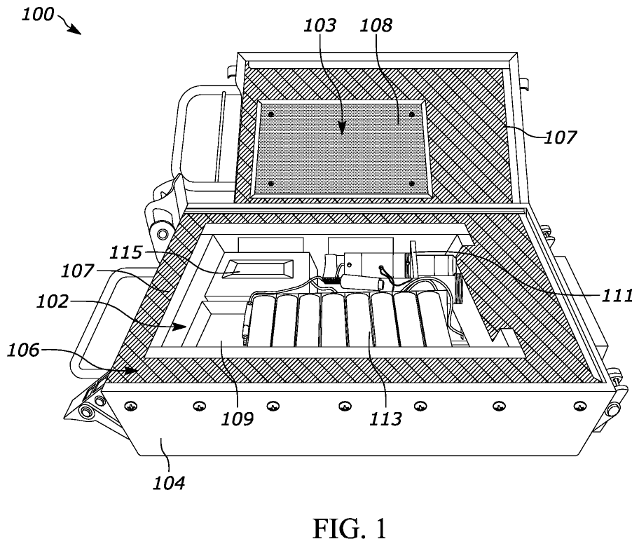

FIG. 1 is an embodiment of an insulated case 100 opened. The insulated case may have an outside surface that is a metallic shell 104. The metallic shell 104 may be made of stainless steel. The insulated case 100 may not include a dedicated air flow inlet or airflow outlet that allows air from the outside to purposefully enter the insulated case when it is secured. The insulated case may include a top portion 103 and a bottom portion 105. The top portion 103 may include insulation 107 throughout the inside of the top portion 103. The inner surface of the top portion 103 may be defined by two insulation layers. For example, the top portion 103 may include a layer of insulation 107 and an insulation board 108. In another embodiment, the top portion 103 may include simply insulation 107 throughout. In yet another embodiment, the top portion 103 may include only an insulation board 108. The insulation may be resistant to extreme heat, such as those exceeding 1400 or 1500 degrees Fahrenheit. Examples of insulation 107 or insulation board 108 utilized may include insulation that utilizes ceramic fiber, silica cloth, quartz, Nextel, Kevlar, fiberglass, Teflon, Vermiculite Fiberglass, silica, Inconel wire, etc.

The bottom portion 105 may include a component storage area 102 that is surrounded by insulation 107. The component storage area 102 may be an area to store various components of the insulated case 100 that allow for analyzing the inside of a furnace, oven, or other type of extreme-heat appliance. The component storage area 102 may include four walls within the bottom portion 105 of the insulated case 100. The perimeter of the component storage area 102 may include a metallic lip or edging. The component storage area 102 may include various areas that are delineated for various components, such as electronic components. The component storage area may include a cooling area 109. The cooling area 109 may be an area that could be utilized for storage of dry ice or another type of cooling solution (e.g. ice pack, ice, etc.). The cooling area 109 may allow air to flow from the cooling area 109 to other areas of the component storage area 102. However, the cooling area 109 may be sealed off from the insulation 107 to avoid heat from entering the component storage area 102.

The component storage area 102 may include a camera area 111 to store a camera. The camera may be utilized to take pictures or videos inside a furnace, an energy source area 113. As explained further below, the camera may be placed in the component storage area 102 and surrounded by the insulation, however, a lens of the camera may need access to outside of the insulated case 100 to take video or images. The energy source area 113 may include a battery pack that receives batteries (e.g. AA, AAA, etc.) to allow operation of the insulated case without the need of an electrical outlet. The component storage area 102 may allow a coolant (e.g. dry ice) that is located in the dry ice area to sit in the cooling area 109. The cooling area 109 may allow the cool air to freely access the various area of the component storage area in order to cool the various electronic devices. However, the component storage area 102 may be sealed off by insulation or the insulation board when the insulated case's top portion and bottom portion are secured.

The component storage area 102 may also include an area delineated for a digital video recorder, which may be called a digital video recorder area 115. The digital video recorder area 115 may allow the digital video recorder to be connected to both the battery source and camera. Thus, cables or other wiring may be accessible between the devices in the component storage area 102. The digital video recorder may thus be sealed off from the hot air that enter from the furnace by the insulation and the shell of the insulated case, but not from the cool air that is utilized in the cooling area 109 of the component storage area 102. As such, the digital video recorder area 105 may be open to the cooling area 109 when the insulated case 100 is closed.

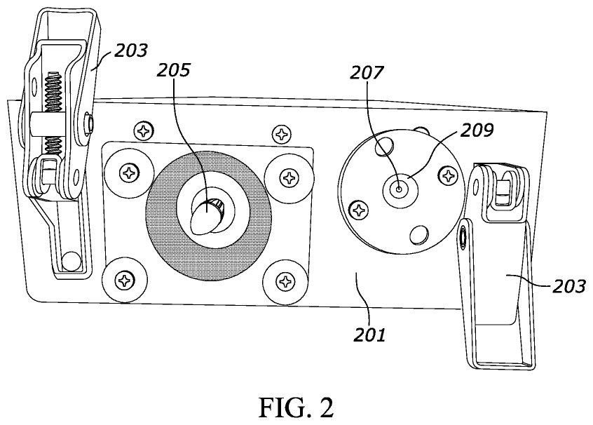

FIG. 2 is a front view of the bottom portion of the insulated case 100. In FIG. 2, a front side 201 of the insulated case 100 may include various components. The front side 201 may include one or more hinges/locks 203 that are configured secure the bottom portion of the insulated case to the top portion when the hinges/locks 203 are engaged. The front side 201 may also include a light source 205. The light source 205 may be utilized to allow the camera to take images of dark areas surrounding a proximity of the insulated case 100. The light source 205 may be a light bulb, LED, incandescence lights, luminescence lights, etc. In FIG. 2, the light source 205 may not have a cover placed on it. However, a heat-resistant cover may be placed over the light source 205 that protects the light source 205 from high temperatures (e.g. 1500 degrees or higher).

Adjacent the light source 205 may be a cut-out 207. The cut-out 207 may be a very small hole in the metallic shell that allows a lens of a camera to abut against the cut-out 207. Thus, the cut-out 207 may provide a camera access to record or capture images outside of the insulated case 100, despite the camera being located in the component storage area 102 of the insulated case 100. The cut-out 207 may be a piercing in the metallic shell. The cut-out 207 may also include a ceramic shield 209 to help absorb heat in high temperature situations. The ceramic shield 209 may surround the cut-out 207 at least partially. The cut-out 207 may have access to the component storage area. Thus, a camera that is at least partially sitting in the component storage area may have a lens that is facing the inside of the insulated case where the cut-out 207 is located. Thus, the cut-out 207 may allow the camera to capture images outside of the case while resting in the component storage area 102. In one example, a camera lens may abut against the cut-out 207 to allow the camera to capture images, but to not allow hot air to freely enter into the component storage area.

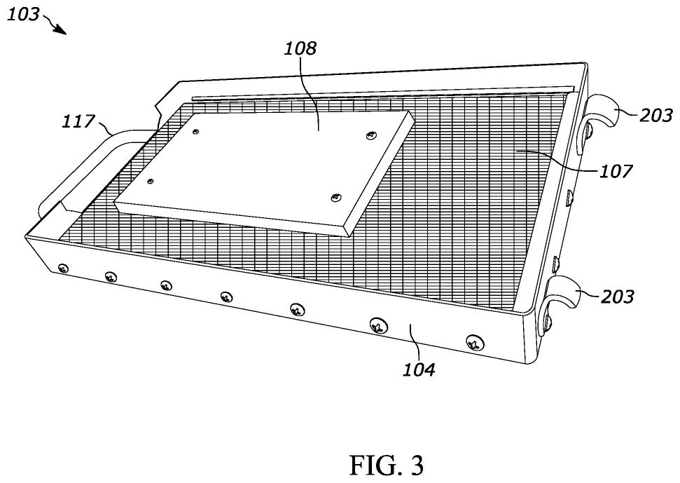

FIG. 3 is a perspective top view of a top portion of the insulated case 100. The top portion 103 may include a metallic shell 104 on an outer layer. The inner layer of the top portion 103 may include insulation 107 throughout. The inner layer may include a soft insulation portion 107 and an insulation board 108. The insulation board 108 may be cut out to fit and nestle inside of the component storage area of the bottom portion of the insulated case 100. Thus, the insulation board 108 may be slightly smaller in dimensions than the component storage area. The insulation board 108 may protrude out of the insulation 107 in one embodiment. In another embodiment, the insulation board 108 may be a different type of insulation than the insulation layer 107. In another embodiment, the insulation board 108 may be a same type of insulation as the insulation layer 107. The top portion 103 may also include a handle 117 that allows the insulated case 100 to be grasped by a user. Additionally, the top portion 103 may include a portion of the one or more hinges/locks 203 that help secure the top portion to the bottom portion.

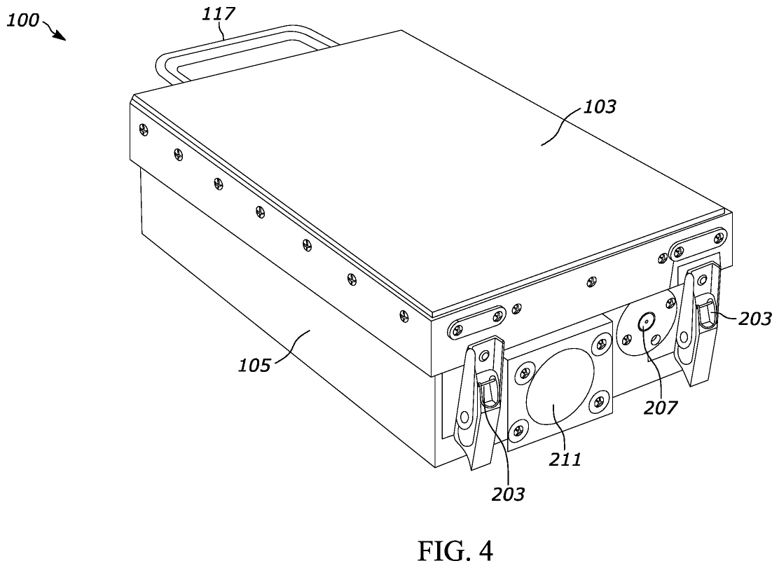

FIG. 4 is a perspective view of the insulated case 100 with a light cover secured. The insulated case 100 may have a handle 117 attached to the back portion. As shown in FIG. 4, the cut-out 207 may be utilized to allow the camera to capture images while placed in the case. The top portion 103 and the bottom portion 105 are secured by the two hinges 203 shown. The insulated case 100 may include a light cover 211. The light cover 211 may be an insulated material to protect the light source (e.g. light bulb) from high temperature situations. The light cover 211 may also be translucent in order to allow light to emit from the light source. In another embodiment, the light cover 211 may also be transparent.

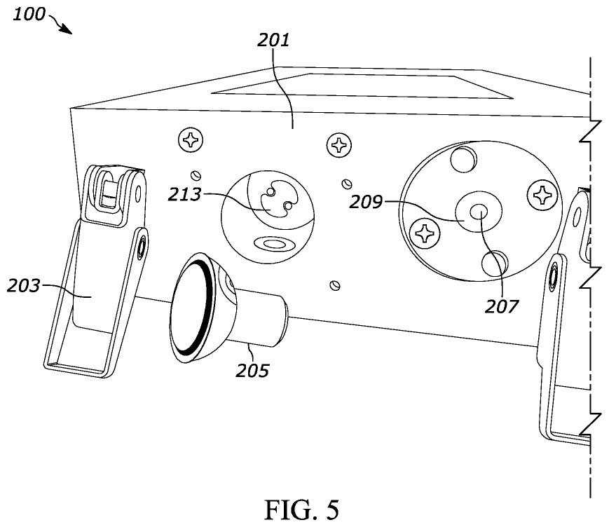

FIG. 5 is a front view of the bottom portion of the insulated case 100 with a light bulb and light cover removed. As shown, the insulated case 100 may have a socket 213 for the light source 205 (e.g., light bulb) to be connected. The socket 213 may have an electrical connection with the energy source (e.g., batteries) in order to draw power to the light source 205 when it is placed and connected to the socket 213. Surrounding the socket 213 may be holes that allow a fastener to be inserted through a light cover and attached to the front side 201 of the insulated case 100. As shown further, the cut-out 207 may also include a ceramic shield 209 to help absorb heat in high temperature situations.

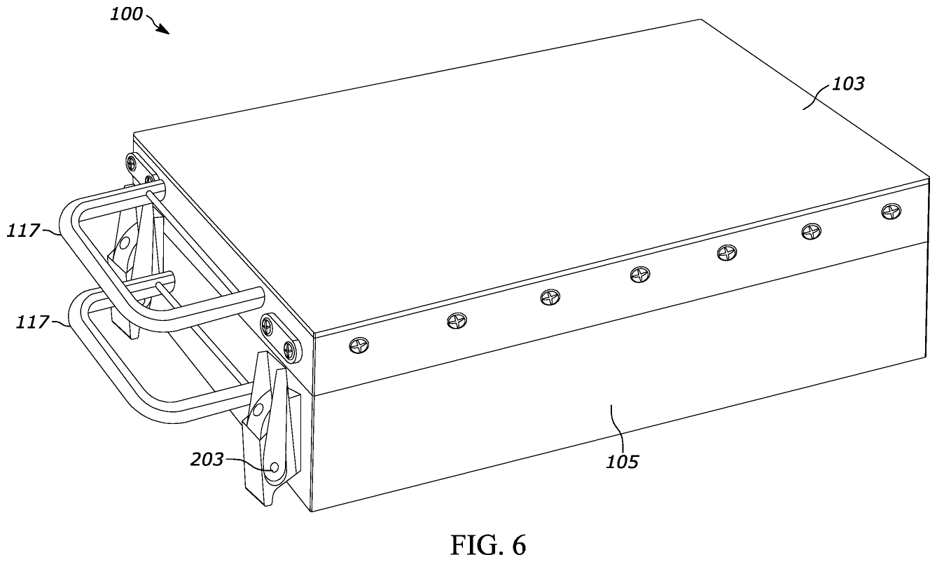

FIG. 6 is a perceptive view of a side portion of the insulated case 100. The insulated case 100 may have one or more handles 117. In one example, a handle 117 may be on the top portion 103. In another example, a handle 117 may be on the bottom portion 105. As shown in FIG. 6, the hinges/locks 203 may secure the top portion 103 to the bottom portion 105.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

1. An insulated case, comprising:
a top portion and a bottom portion of the insulated case, wherein bottom portion include a metallic shell and an insulation portion surrounding an inside of the insulated case, wherein the insulation is resistant to heat at 1500 degrees Fahrenheit, wherein the bottom portion includes a cut-out located on an outer side of the metallic shell;
a component storage area defined in the insulated portion that includes a camera, an energy source, a digital recorder, and a coolant, wherein the component storage area is sealed off absent access to the cut-out, wherein the component storage area further includes a cooling area, wherein the cooling area is configured to accommodate the coolant and allow cool air to flow from the cooling area to other areas of the component storage area; and
a camera located in the component storage area, wherein the camera is configured to capture videos via the cut-out.

2. The insulated case of claim 1, wherein the coolant is adjacent the energy source and the digital recorder.

3. The insulated case of claim 1, wherein the component storage area is sealed off from the insulation when the top portion is secured to the bottom portion.

4. The insulated case of claim 1, wherein the top portion includes an insulation board configured to sit within the component storage area when the top portion is secured to the bottom portion.

5. The insulated case of claim 1, wherein the camera includes a first portion located in the component storage area and a second portion located in the insulation portion, wherein the second portion includes of the camera includes a lens located in the insulation portion.

6. The insulated case of claim 1, wherein the insulated case does not to include a dedicated air flow inlet or airflow outlet.

7. The insulated case of claim 1, wherein the cut-out is surrounded by a ceramic shield.

8. The insulated case of claim 1, wherein the camera further includes a lens abutting against the cut-out.

9. An insulated case, comprising:
a top portion and a bottom portion of the insulated case, wherein the top and bottom portion include a metallic shell and an insulated portion filled with insulation, wherein the insulation is resistant to heat at 1500 degrees Fahrenheit, wherein the bottom portion includes a first cut-out and a second cut-out located on an outer side of the bottom portion, wherein the second cut-out includes a receiving socket for a light bulb; and
a component storage area that includes a camera area with access to the first cut-out, and a cooling area, wherein the component storage area is surrounded by the insulation portion and the component storage area is further defined by a perimeter, wherein the insulation portion of the top portion seals the component storage area when the top portion is secured to the bottom portion.

10. The insulated case of claim 9, wherein the insulated case includes a handle attached to the top portion or the bottom portion.

11. The insulated case of claim 9, wherein the insulated case includes a handle attached to the top portion and the bottom portion.

12. The insulated case of claim 9, wherein the metallic shell is made of stainless steel.

13. The insulated case of claim 9, wherein the second cut-out is covered by a ceramic cover that is translucent.

14. The insulated case of claim 9, wherein the top portion is completely filled with insulation.

15. The insulated case of claim 9, wherein the first cut-out is two millimeters in diameter or smaller.

16. The insulated case of claim 9, wherein the insulated portion includes an insulated board, wherein the insulated board seals the component storage area when the top portion is secured to the bottom portion.

17. An insulated case, comprising:
a top portion and a bottom portion of the insulated case, wherein the top and bottom portion include a metallic shell and an insulated portion filled with insulation, wherein the insulation is resistant to heat at 1400 degrees Fahrenheit, wherein the bottom portion includes a first cut-out located on an outer side of the bottom portion; and
a component storage area located in the bottom portion and that includes a camera area with access to the first cut-out, wherein the component storage area further a cooling area that allows air flow to the camera area of the component storage area, wherein the cooling area is configured to accommodate a coolant and allow cool air from the coolant to flow from the cooling area to other areas of the component storage area wherein the component storage area is surrounded by the insulation portion of the bottom portion and the component storage area is defined by a metallic perimeter, wherein the component storage area is sealed off from the insulated portion when the top portion and the bottom portion of the case is assembled.

18. The insulated case of claim 17, wherein camera area is connected to the first cut-out via a passageway located in the insulated portion.

19. The insulated case of claim 18, wherein the passageway is surrounded by the insulation.

20. The insulated case of claim 17, wherein the bottom portion includes a second cut-out located on an outer side of the bottom portion, wherein the second cut-out includes a receiving socket for a light bulb.
